(19) United States
(12) Patent Application Publication
(10) Pub. No.: US 2009/0096200 A1
(43) Pub. Date: Apr. 16, 2009

(54) Reflective seatbelts for increasing safety for patrol officers and motorists

(76) Inventor: Elaine Jamison, Forest Park, IL (US)

Correspondence Address: ELAINE JAMISON, 320 Circle Avenue, Forest Park, IL, 60130, US

(21) Appl. No.: 12/150,124

(22) Filed: Apr. 26, 2008

Related U.S. Application Data
(60) Provisional application No. 60/998,882, filed on Oct. 15, 2007.

(51) Int. Cl. B60R 22/06; B60R 22/00

(52) U.S. Cl. 280/804; 297/474

(57) ABSTRACT

A reflective seatbelt device for use with a motor vehicle for determining fastened and unfastened seatbelt positions of motorists and passengers which will prevent patrol officers from departing their vehicles while viewing proper usage of a seatbelt. The reflective material is constructed extending the webbed fabric of the shoulder/torso cross strap of a seatbelt assembly and can be seen on both sides of the seatbelt, enabling patrolling officers to verify seatbelt position and not have to exit their vehicles. The reflective seatbelt device will keep patrolling officers out of the direct line of traffic for their safety; thus protecting them from traffic related injuries and fatalities. The reflective seatbelt protects motorists and passengers by persuading them to buckle up knowing that it is obvious for patrol officers to see unfastened seatbelts during the day and night driving.

### CROSS REFERENCE TO RELATED APPLICATION.

This Non-Provisional patent application that claims right of priority to U.S. Provisional Application No. 60/998,882 filed Oct. 15, 2007, Reflective Seatbelt.

### FIELD OF THE INVENTION

The invention relates to a vehicle seatbelts for motor vehicles or the like, and more importantly, ensuring the safety of patrolling officers, motorists and passengers by having the ability to determine when the vehicle seatbelt is in a fastened or unfastened position, patrolling officers will have the advantage of viewing the seatbelt position from within their vehicles and not have to worry about traffic hitting them at night and during the day as well. Patrol officers are any state, city and federal law enforcer.

### BACKGROUND OF THE INVENTION

Since seatbelt laws were enacted, the problem remains to get people to buckle up for safety at night and during the day. It is not easy for patrol officers to see unbuckled motorist at night, patrolling officers usually deal with high volume traffic areas, and more police officers in the United States are killed and injured in traffic incidents than homicidal incidents or guns. Patrolling officers are loosing their lives in traffic incidents from being outside the protection of their vehicles, while standing outside; they are in proximity of the edge of the roadways, especially during night time hours when officers are less visible.

With the ability to determine if occupants are properly wearing their seatbelts in a fastened position, patrolling officers can make the determination from the safety of their vehicles. It is expected that by adding this feature as part of the existing seatbelt design, officers will not be put needlessly at risk and will save lives. Many people know that it's difficult for patrol officers to see unbuckled motorists and passengers at night and as a result seatbelt usage is lower. Additional officers are needed for patrolling seatbelt usage. This duty keeps police officers from performing other important responsibilities.

Nation-wide traffic fatality rates are the highest at night and account for 25 percent of traffic fatalities. Unbelted drivers or passengers are four times more likely to die if thrown from the car.

It is too difficult for patrol officers to identify unbuckled motorists and passengers at night. Current seatbelt observation methods are costly, and involve excessive man-power, high-tech infer-red devices and barricades. The statistical proof is over whelming, the NHTSA (National Highway Traffic and Safety Administration) found that more than 15,000 passenger's vehicle occupants died in traffic crashes between the night-time hours of 6:00 p.m. and 6:00 a.m. Two thirds of those killed were not wearing their seatbelts at the time of the crashes.

A variety of vehicle manufacturers and safety organizations have carried out studies of seatbelt usage in vehicles, and these studies have confirmed that vehicle occupants wearing seatbelts are safer and have enhanced protection in the event of a crash than those who do not wear seatbelts. As a result, public awareness campaigns all over the United States have been started to encourage the use of seatbelts in vehicles, and many authorities have actually enacted seatbelt laws to mandate such use.

Currently, in vehicle crash situations, a large number of preventable fatalities and serious injuries occur each year as a result of failure of vehicle occupants to buckle up for safety and also having patrolling officers standing in an outside environment to view seatbelt usage.

Officials are faced with the difficult and error-prone challenge of performing quick visual checks of seatbelt shoulder harnesses to ascertain whether each occupant in each passing vehicle is properly buckled in.

### SUMMARY OF THE INVENTION

A reflective seatbelt device for use by occupants in vehicles, it provides the current invention seatbelt systems with webbed fabric that has reflective material sufficiently configured in and/or affixed to surface extending along the cross shoulder/torso strap. The reflective seatbelt has more than one way of production, but is not limited to the method listed herein this document.

The reflective seatbelt device will increase protection for patrolling officers, for the reason that the patrolling officer will not have to leave their vehicles and stand outside to determine if the seatbelt is being used in the fastened position. At the same time, motorists will be persuaded to buckle up with this added feature; therefore, lives will be saved and serious injuries will be prevented.

The primary goal is to keep patrol officers, motorists and passengers safe on our traffic roadways.

In accordance with the present invention and the reflective seatbelt device for use with a vehicle, the reflective seatbelt device comprise of a seat assembly having reflective material constructed in the webbed fabric and/or affixed to the surface extending along the shoulder/torso cross strap. The shoulder/torso cross strap is adapted to be occupied by motorist in a fastened position. The seatbelt assembly has seatbelt webbing and a seatbelt fastening member. The seatbelt assembly is moveable between a fastened position and an unfastened position. In the fastened position, the seatbelts will display the reflective material that is constructed in the webbed fabric and/or affixed to the surface extending along the shoulder/torso portion of the seatbelt strap to keep patrol officers from departing their vehicles to view usage, and will also persuade motorists to buckle up.

The current observation methods that patrol officers now use to determine seatbelt usage include a barricade check point with teams of officers, (a one lane drive through is created at the entrance officer's stand outside with a flash light to view fastened and unfastened seatbelts). Another method includes both observation officers and several pursuit vehicles (when a motorist is spotted the observing officer radios ahead to pursuit vehicle to make the stop). Additional tactic is the use of infrared goggle to patrol night time seatbelt usage. The reflective seatbelt could be the solution to the problems officers have with seatbelt observation during the day and night.

A reflective seatbelt will support patrolling officers ability to verify if a vehicle seatbelt is in a fasten or unfasten position from within their vehicles, whether they are approaching a vehicle from the front or following a vehicle from behind with out having to exit their vehicles, this will prevent officers from having to depart from their vehicles and be put at risk of being injured or kill in traffic incidents. The reflective seatbelt can aid in keeping officers within the protection of their vehicles while performing this task, especially at night when the officers are less visible, and not be hurt while in the line of duty.

A reflective seatbelt device can aid in preventing serious and fatal injuries of patrolling officers, motorists and passengers. The reflective seatbelt can assist in deceasing the amount of expensive equipment and man power cost used for night observation and the day as well.

A reflective seatbelt can be used in conjunction with all traffic enforcement camera systems to determine if motorist were wearing their seatbelts at the time of traffic violation or accident.

A reflective seatbelt can be used with children restraint systems belts to aid in visualization that the child is properly belted into the car seat.

In accordance with further aspects of the device, the reflective seatbelt will be custom made having various designs, patterns, manufacturer logos, symbols, names, and text etc. and can be seen with various light including, but not limited to natural light, flash light, head lights etc.

In further aspects of the device, the reflective seatbelt comprises an exterior fascia and backside; when the reflective material is constructed and/or affixed to the surface of the seatbelt webbing of the cross shoulder/torso strap it can be seen on both sides of the seatbelt. The formation of the reflective material into the seatbelt webbing can be produced to create any symbols, logos, images, patterns, designs or text and colors in the seatbelt webbed fabric.

In addition with further aspects of the reflective seatbelt, the reflective material is constructed and/or affixed to the surface of the webbed fabric as part of the seatbelt substantially.

In accordance with added aspects of the device, the reflective seatbelt will further determine when the seatbelt assembly is in the fastened position. When the seatbelt assembly is in the fastened position, the reflective material is seen because the reflective material can be seen on both sides of the seatbelt. It allows officers to detect the seatbelt fastened position if they are approaching the vehicle from the front or following a vehicle from behind. Seatbelt manufacturers already have the equipment and facilities needed for production.

In accordance with a further aspect of the method, the reflective seatbelt can be seen more than fifty feet away or more. This aids in protecting and saving patrol officers, motorists, and passengers lives.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, and is briefly described herein below.

### BRIEF DESCRIPTION OF THE DRAWINGS

The added features which are characteristic of the present seatbelt invention, as to its structure, organization, use and method of operation, together with further objectives and advantages thereof, and is better understood from the following drawings in which a presently preferred embodiment of the invention is illustrated by way of example. It is understood, that the drawings are for the purpose of illustration and description only, and are not intended as a definition of the limits of the invention in the accompanying drawings.

FIG. 1 Is a front perspective view of a belted occupant in a fastened position with the shoulder/torso cross strap of a vehicle seatbelt displaying reflective material extending along the seatbelt webbed fabric using a star pattern and can be seen on both sides of the seatbelt.

FIG. 2 Is a side perspective view of a belted occupant in a fastened position displaying the reflective material extending along the webbed fabric of the shoulder/torso cross strap of vehicle seatbelt according to the present invention displaying a star pattern.

FIG. 3 Is a rear perspective view of belted occupants in a fastened position displaying the reflective material extending along the webbed fabric shoulder/torso cross strap of vehicle seatbelt according to the present invention, displaying a star pattern on the driver side and a GM manufacturer logo on the passenger side, and can be seen on both sides of the seatbelt.

FIG. 4 Is an enlarged perspective view of the reflective material in a star pattern in the webbed fabric shoulder/torso cross strap of the seatbelt and can be seen on both sides of the seatbelt.

FIG. 5 Is an enlarged perspective view of the reflective material in a diamond pattern in the webbed fabric shoulder/torso cross strap of the seatbelt and can be seen on both sides of the seatbelt.

FIG. 6 Is an enlarged perspective view of the reflective material in a stripped pattern in the webbed fabric shoulder/torso cross strap of the seatbelt and can be seen on both sides of the seatbelt.

FIG. 7 Is block diagrams illustrating the steps of a method for practicing the present invention; Block 602 shows first step of practicing the present invention using the present invention seatbelt assembly, having a manufacturer's formation and webbing process; Block 604 shows second step of practicing the present invention by having a reflective material selecting a design, pattern etc. to be fixed to webbed fabric of the seatbelt; Block 606 shows third step of practicing the present invention which is the manufacturing process to construct the reflective material in the seatbelt webbed fabric.

furthermore, the present invention is not limited to these preferred embodiments and various variations and modifications may be made without departing from the scope of the present invention.

### DETAILED DESCRIPTION OF A PREFERRED EMBODIMENT

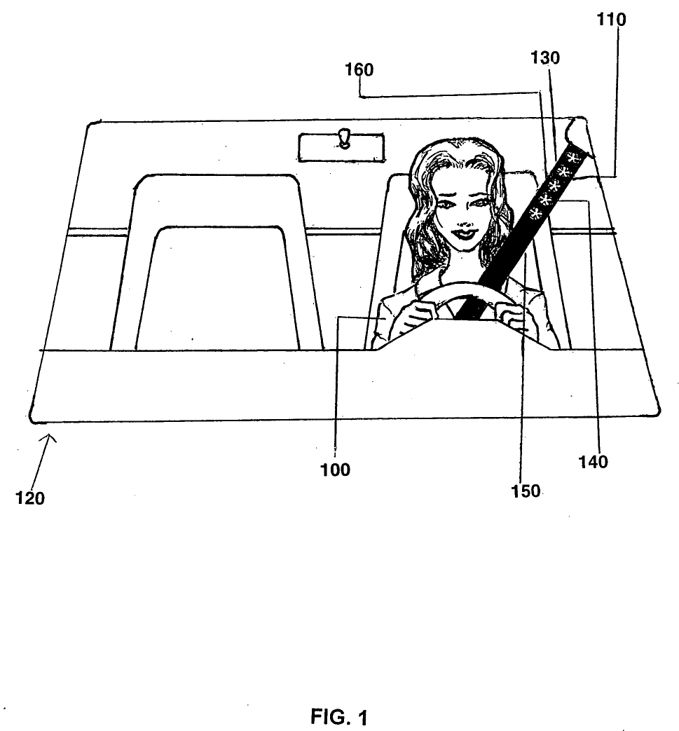

Referring to the figures, as best seen in FIG. 1, shows a belted occupant 100 with a reflective seatbelt device 110 for use with a vehicle 120 in a fastened position 150. The reflective seatbelt device 100 includes a seatbelt assembly 130 having a shoulder/torso cross strap 140 of a seatbelt assembly 130, a reflective material 160 of the seatbelt 130 for determining occupant use in a fastened position 150 can be seen with little effort in any light (natural daylight, head lights, street lights, flash lights, etc.), enhancing patrol officers ability to verify seatbelt 130, 150 use at night and during the day, this will increase seatbelt usage at night and in the day as well by occupants.

A reflective seatbelt device 110; wherein said reflective material 160 is constructed in the webbed fabric extending along the shoulder/torso portion of the seatbelt strap 140 of a vehicle and can be seen on both sides of the vehicle seatbelt; and wherein said reflective material 160 is selected from the group consisting of reflective materials 160; in which the reflective material comprise where in one or more reflective materials 160 are related from the group consisting of: retro-reflective materials 160, retro-reflective fabrics, microscopic glass beads, acrylics, threads, yarns, paints, primer, sealers, leathers, synthetic leathers, artificial leathers, vinyls, nylons, fibers, inks, glass, beads, films, silk screens, plastics, plastic film, glass spheres, in various colors including neon colors, but, is not limited to these reflective materials 160 to produce illumination.

A reflective seatbelt device 110; wherein said reflective material 160 is selected from the group consisting of reflective grades; diamond, engineering, commercial, high-intensity, advertisement, vehicle license plate, and nay other specialty commercial grades but, is not limited to these reflective grades that can be added materials to produce and construct into the webbing seatbelt fabric.

A reflective seatbelt device 110; in which the methods of constructing the reflective material 160 in the webbed fabric and/or affixed to surface extending along the shoulder/cross strap of the seatbelt comprise where in one or more technique are related from the group consisting of: woven, interwoven, weaved, interweaved, webbed, sewed, stitched, embroidered, other techniques include: printed, bonded, stenciled, calligraphy, stamped, emblem, sprayed, stapled, studded, riveted, taped, thermal adhesive, heat-activated adhesive to adhere, substantially through the manufacturer webbing process into the cross shoulder/torso strap of the webbing of the said seatbelt of a vehicle, but is not limited to these methods.

The cross shoulder/torso strap 140 of the seatbelt assembly 130 is adapted to be occupied by a belted occupant 100 in the fastened position 150 (FIG. 1). The interior seatbelt 130 of the vehicle 120 provides front seatbelts and rear seatbelt assemblies left and right; it should also be valued that the reflective seatbelt device 110 of the present invention is equally adapted for use in vehicles with other seating arrangements, such as, for example (rear occupants and right side driving—not shown).

The seatbelt assembly 130 has seatbelt webbing and a buckle or seatbelt fastening member. Seen in FIG. 1, an extending end portion of the seatbelt webbing is wound on a recoil and tensioning device located near an interior floor of the vehicle, adjacent to an outboard edge of the seat assembly 130, a anchor member may alternately be affixed to the interior floor or to another part of the vehicle (not shown). An intermediate portion of the seatbelt webbing passes through a guide ring that is positioned in vertically space relation from the interior floor. A tongue plate is slid ably carried by the intermediate portion of the seatbelt webbing that is between the guide ring and the anchor member, the rear row of seatbelt assemblies having an all-belts-to-seat apparatus (ABTS).

In accordance with the present invention, there is also disclosed a method for generating and transmitting a reflective seatbelt device 130 of a vehicle 120. The methods comprises a first step of determining when the reflective seatbelt device 110 is in a fastened position 150, the belted occupant 100 occupies a seat with the seatbelt assembly 130 in a fastened position 150 will display the reflective material 160.

In accordance with another aspects of the method, the reflective seatbelt 110 will not only save the lives of motorists but will also save the lives of patrol officers, whereas patrol officers are able to safely determine if seatbelt is in a fastened or unfastened position 100 in the safety of their vehicles and not having to be in direct association with traffic to view seatbelt usage. The reflective material 160 will not affect the spool design or overall diameter of the wound belt because the amount of constructed reflective material 160 is very small and will still have the illuminating affect with any light.

The said seatbelt further comprising a use in conjunction with all traffic enforcement camera systems to determine if motorists were using their seatbelt at the time of traffic violation or accident.

The said seatbelt further comprising a use with children restraint system belts to aid in visualization that the child is properly belted into the car seat while in motion.

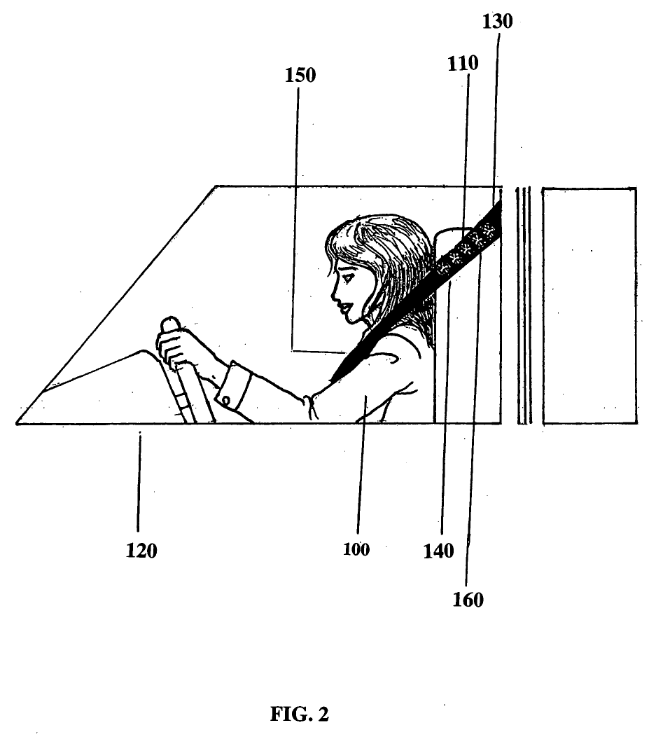

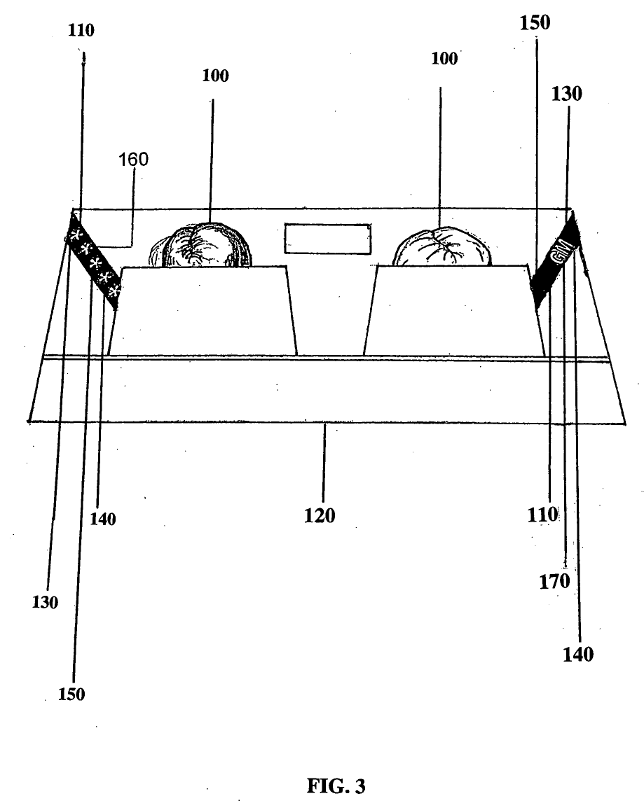

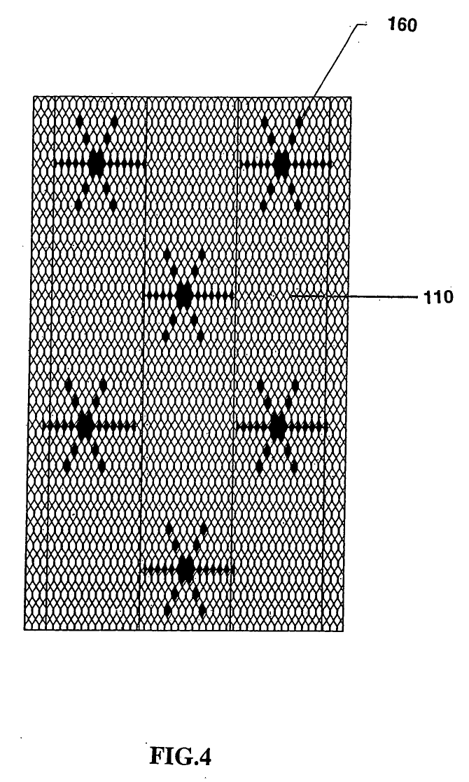

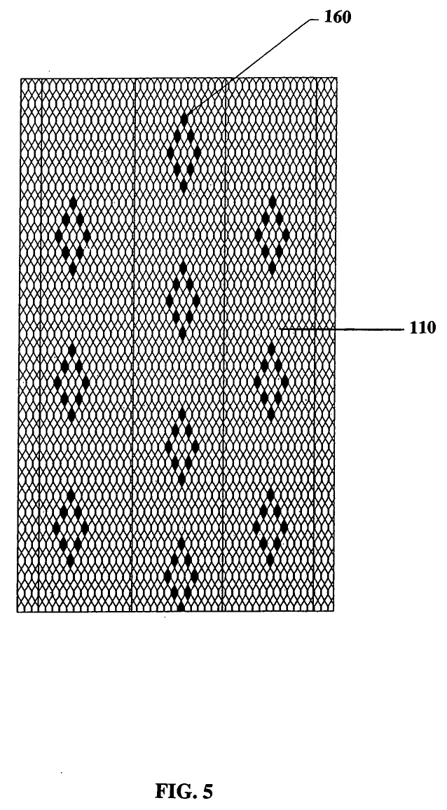

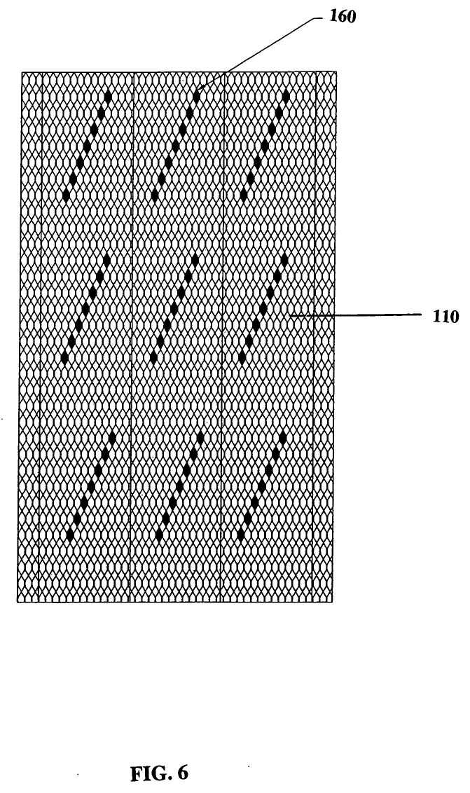

FIG. 1 Shows a front view of a belted occupant 100; seatbelt webbed fabric 110; motor vehicle 120; seatbelt assembly 130; seatbelt shoulder/torso cross strap 140; seatbelt assembly in fasten position 150; reflective material 160 in a star pattern; FIG. 2 Shows a side view belted occupant 100; seatbelt webbed fabric 110; motor vehicle 120; seatbelt assembly 130; seatbelt shoulder/torso cross strap 140; seatbelt assembly in fasten position 150; reflective material 160 in a star pattern; FIG. 3 Shows a rear view belted occupants 100; seatbelt webbed fabric 110; motor vehicle 120; seatbelt assembly 130; seatbelt shoulder/torso cross strap 140; seatbelt assembly in fasten position 150; reflective material 160 in a star pattern; and reflective material 160 in a manufacture logo 170 design. FIG. 4 Shows an enlarged view of the seatbelt webbed fabric 110; with a star pattern of reflective material 160; FIG. 5 Shows an enlarged view of the seatbelt webbed fabric 110; with a diamond pattern of reflective material 160; FIG. 6 Shows an enlarged view of the seatbelt webbed fabric 110; with a stripped pattern of reflective material 160;

It is to be understood that even though numerous characteristics and advantages of the present invention have been set forth in the preceding description, together with details of the makeup and purpose of the invention, changes may be made in detail, mainly in material of reflective materials 160, symbols, logos 170, names, images, patterns, designs, text, shapes and size of arrangement of reflective material 160 within the principles of the invention to the full extend indicated in general meaning of the terms in which the appended claims are express.

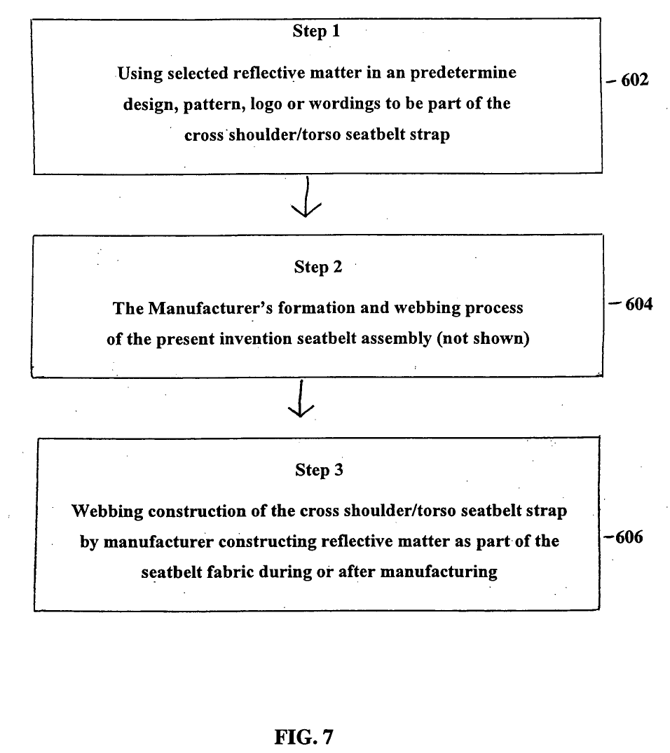

FIG. 7 Shows steps of a method in accordance with the present invention; Block 602 shows first step of practicing the present invention is using the present invention seatbelt assembly, having a manufacturer's formation and webbing process; Block 604 shows second step of practicing the present invention by having a reflective material selecting a design, pattern etc. to be fixed to webbed fabric of the seatbelt; Block 606 shows third step of practicing the present invention which is the manufacturing process to construct the reflective material in the seatbelt webbed fabric.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

Furthermore, the present invention is not limited to these preferred embodiments and various variations and modifications may be made without departing from the scope of the present invention.

1. A Reflective Seatbelt device for determining if a seatbelt is in the fastened or unfastened position.

2. The reflective seatbelt device of claim 1 wherein seatbelt assembly is adapted to be occupied by motorist and/or passengers in a fastened position.

3. The reflective seatbelt device of claim 1 wherein seatbelt device comprising; a present invention seatbelt assembly; webbed seatbelt fabric of the shoulder/torso cross strap; and reflective material.

4. The reflective seatbelt device of claim 1 wherein reflective material is selected and constructed extending along the shoulder/torso cross strap in a selected designs, patterns, logos, symbols, images, shapes, text; the reflective seatbelt for use in determining when the seatbelt is in a fastened or unfastened position.

5. The reflective seatbelt device of claim 1 wherein reflective material is comprised where in one or more reflective materials are related from the group consisting of: retro-reflective, retro-reflective fabrics, microscopic glass beads, acrylics, threads, yams, paints, primer, sealers, leathers, synthetic leathers, artificial leathers, vinyls, nylons, fibers, inks, glass, beads, films, silk screens, plastics, plastic film, glass spheres but, is not limited to these reflective materials to produce illumination.

6. The reflective seatbelt device of claim 1 wherein reflective seatbelt device comprising of the seatbelt assembly having seatbelt elongated web of material and a seatbelt fastening member; the seatbelt assembly is movable between a fastened and unfastened position.

7. The reflective seatbelt device of claim 1 wherein reflective seatbelt device comprised of a seatbelt assembly having reflective material constructed extending along the webbed fabric of the cross shoulder/torso strap.

8. The reflective seatbelt device of claim 1 wherein reflective seatbelt device having seatbelt webbing and a seatbelt fastening member; said seatbelt having reflective material mean for determining when the seatbelt is fastened into the fastening member.

9. The reflective seatbelt device of claim 1 wherein reflective seatbelt device that provide reflective material according to claim 5, wherein said is reflective seatbelt is an obvious illuminating material, and wherein said reflective material is adapted to release light.

10. The reflective seatbelt device of claim 1 wherein a reflective seatbelt device comprised of the present seatbelt assembly and said reflective material forming a reflective seatbelt; said reflective material is constructed in or affixed to the surface extending along the webbed fabric of the shoulder/torso cross strap.

11. The reflective seatbelt device of claim 1 wherein a reflective seatbelt device in a fastened position the seatbelt displays reflective material in any light; natural daylight, headlights, flashlights, etc.

12. The reflective seatbelt device of claim 1 wherein a reflective seatbelt device having custom made designs, patterns, logos, symbols, images, shapes, text, but is not limited to these markings with reflective material.

13. The reflective seatbelt device of claim 1 wherein a reflective seatbelt device; comprises an exterior fascia and backside; having reflective material constructed extending along the shoulder/torso cross strap. The reflective material can be seen on both sides of the seatbelt webbed fabric strap.

14. The reflective seatbelt device of claim 1 wherein a current invention seatbelt assembly invention, and said reflective material, forming a reflective seatbelt. Said reflective material is constructed in and/or affixed to the webbed fabric extending along the shoulder/torso strap extending along the webbed fabric of the seatbelt in any symbols, logos, shapes, images, names, patterns, designs and text, thus establishing fastened or unfastened position for use with motor vehicles.

15. The reflective seatbelt device of claim 1 wherein a reflective seatbelt device comprising; a present invention seatbelt assembly using the webbed fabric of the cross shoulder/torso strap with reflective material in any predetermine designs, patterns, names, symbols, text and logos.

16. A method of fabricating a reflective seatbelt device may consist of the steps; providing a seatbelt elongated webbing of material(s); applying reflective by the manufacturing process or by hand.

17. The method of claim 16 having reflective material and selecting a blueprint of any symbols, logos, shapes, images, names, patterns, designs and text constructed in and/or affixed to the surface of the seatbelt webbed fabric.

18. The method of claim 16 wherein the reflective materials is comprised where in one or more reflective materials are related from the group consisting of: retro-reflective, retro-reflective fabrics, microscopic glass beads, acrylics, threads, yarns, paints, primer, sealers, leathers, synthetic leathers, artificial leathers, vinyls, nylons, fibers, inks, glass, beads, films, silk screens, plastics, plastic film, glass spheres but, is not limited to these reflective materials to produce illumination

19. The method of claim 16 wherein the applying reflective materials by the manufacturing process or by hand before or after manufacturing of the seatbelt webbed fabric.
